(19) United States
(12) Patent Application Publication
(10) Pub. No.: US 2007/0146318 A1
(43) Pub. Date: Jun. 28, 2007

(54) Pointing device with an integrated optical structure

(75) Inventors: Sung Chul Juh, Seoul (KR); Kyoung Un Chung, Seoul (KR); Yoon Soo Kim, Seoul (KR); Kyu Deuk Cho, Seoul (KR); Tae Woo Kim, Seoul (KR); Dong Jung Yong, Seoul (KR); Jae Young Jo, Seoul (KR); Seung Hai Oh, Gyeonggi-do (KR); Sun Jun, Gyeonggi-do (KR); Kyu Min Hwang, Seoul (KR)

Correspondence Address: VENABLE LLP, P.O. BOX 34385, WASHINGTON, DC, 20043-9998, US

(73) Assignees: MOBISOL INC., Seoul (KR); Korea Electronics Technology Institute, Seongnam-si (KR)

(21) Appl. No.: 10/592,134

(22) PCT Filed: Mar. 10, 2005
(86) PCT No.: PCT/KR05/00690

§ 371 Date: Sep. 8, 2006

(30) Foreign Application Priority Data
Mar. 11, 2004 (KR) 10-2004-0016663
Mar. 12, 2004 (KR) 10-2004-0016955
Mar. 30, 2004 (KR) 10-2004-0021395
Jul. 13, 2004 (KR) 10-2004-0054530

(51) Int. Cl. G09G 5/08

(52) U.S. Cl. 345/157

(57) ABSTRACT

The present invention relates to a micro-optical pointing device suitable for mobile terminals such as a cellular phone and PDA. A disclosed pointing device includes a light source emitting light rays to a subject; a contact member comprising a lattice type or perceivable pattern, which reflects an image of the moving subject; and an automatic transfer device restoring the contact member moved by a finger. The pointing device may further include a flip chip containing an image sensor, which converts the acquired image into an electronic signal, and a circuit for signal processing. The pointing device may include an integrated optical structure comprising a condensing lens, a specular surface, a light output part, and an image-formation lens. The pointing device may include a light guide structure that a parallel light prism lens, an image-formation lens, and a mask for blocking disturbance ray are formed into a single part.

### TECHNICAL FIELD

The present invention relates to an optical pointing device with an integrated optical structure and, more particularly, a micro-optical pointing device suitable for a mobile device such as a cellular phone and a personal digital assistant (hereinafter referred to as “PDA”), which is applicable to an electronic device requiring a waterproof and dustproof pointing device by forming a microelectronic circuit using a wafer-scale flip chip semiconductor package and integrating the same with an integrated optical structure; can improve optical efficiency by concentrating light from a light source and blocking disturbance ray; can lengthen operating time of a mobile terminal employing secondary batteries by determining whether or not the terminal is used and switching the pointing device into a power saving mode to reduce power dissipation when the mobile terminal is not used; and can be mounted on a small mobile terminal by integrating and packaging optical and other structures within a small space.

### BACKGROUND ART

A general optical pointing device acquires an image of a surface on which a mouse moves, using an optical device and a two-dimensional optical senor array including complementary metal oxide semiconductor (hereinafter referred to as “CMOS”) image sensors. When the mouse is at a stationary state, the acquired image does not change. However, when the mouse moves, the acquired image changes. To calculate movement of the mouse using the change of image acquired, a motion estimation method is used.

FIG. 1. is a schematic diagram illustrating a conventional pointing device. Referring to FIG. 1, light generated from a light-emitting diode (hereinafter referred to as “LED”) (10) illuminates a surface of an object and the light reflected from the object goes through an image-formation lens (20) to form an image on an image sensor (30). The image sensor (30) converts the formed image into an electronic signal and then transfers the electronic signal to a data processing part. The data processing part analyzes the image changed with time due to the movement of the object and converts the direction and quantity of movement of the object into two-dimensional data.

A conventional optical mouse perceives a change of position by moving an optical member and sensor while a contact member, i.e., a perceivable pattern, is fixed. Therefore, because to move the optical member and sensor is to move the mouse itself, the conventional optical mouse is not applicable to a mobile device such as a cellular phone or PDA, which is small and requires high mobility and miniaturized accessories. Moreover, the conventional optical mouse is inconvenient for conducting operation such as game because a user has to have the mouse itself.

The Korean patent publication number 2002-0073432, Brosnan, discloses a method for selecting a menu and identifying a user of a portable electronic device and the portable electronic device. Brosnan's portable electronic device is operated without using an additional device by using a menu display having a plurality of menu items and a menu item pointer, and identifies a specific user by analyzing an operation pattern. However, such a conventional art has to rub an imaging surface of the electronic device with a finger to move the menu item pointer. To move the menu item pointer to a particular menu item, a user has to rub the imaging surface several times and the accuracy of finger movement on the imaging surface influences detection of menu item.

The Korean patent publication number 2002-0063338, Lim, discloses a technology of using a portable mobile device itself as a pointing device by distinguishing whether a pointing function button is pressed or not. The disclosed portable mobile device has an advantage that it performs a pointing function without adding a separate pointing device although the portable mobile device is miniaturized by minimization of display space. However, Lim's portable mobile device has a disadvantage that in order to scroll a desired display screen the mobile device itself has to be moved.

The Korean patent publication number 2002-0075243, Hwang et al., discloses a personal portable terminal adopting a principal of an optical sensor mouse, which achieves a rapid pointer movement compared to a conventional PDA with a touch screen and prevents the screen from being dimmed due to use of the touch screen. However, the disclosed art has to use a separate hardware button to execute a selected program and move the PDA itself to set up a position of point.

On the other hand, in a general pointing device, a CMOS image sensor, which converts a formed image into an electronic signal, and a signal processing unit to process data from the CMOS image sensor are formed as a semiconductor chip. The semiconductor chip is manufactured with a dual inline package (hereinafter referred to as “DIP”) method. In the DIP method, a wafer is joined to a lead frame by using a wire bonding and, then, is enclosed by resin. Here, a hole is formed on the top of a cover so that light is reached to an imaging surface through the hole. However, the DIP method requires an additional space for the lead frame and wire bonding and, therefore, is not applicable to an electronic device requiring a very small optical mouse such as a cellular phone.

To manufacture a micro-optical pointing device, a packaging technology up to a wafer-size level has to be applied. Generally, a CMOS image sensor for image-formation and a signal processing unit for converting signals from the CMOS image sensor into two-dimensional moving data are included into a single chip. To mount a wafer on an integrated circuit board for minimization and thinning, an auxiliary circuit board is used. The wafer is joined with the supporting circuit board using wire bonding. Such a method is known as a chip on board (hereinafter referred to as “COB”). However, the COB method has some trouble in performing automation such as a surface mount technology (SMT) and integration because of an additional process according to use of the separate auxiliary circuit board.

In another aspect, a pointing device chiefly uses an LED as a light source in illuminating for image acquisition. The illumination adopts a structure for minimizing errors caused by a specular light from a surface. A convex lens or an aspheric lens having characteristics similar to the convex lens is used as an optical system for image-formation. As shown in FIG. 1, in a conventional optical image acquisition device, light from an LED illuminates a surface of an object and the light reflected from the object forms an image on an image sensor (30) through an image-formation lens (20).

Recently, a portable wireless device capable of executing application programs with a graphic user interface has been widely spread. To develop a pointing device of a portable wireless device for effective use of these application programs, research and development for integrating all optical members in a small space, minimizing loss of light source, and maximizing a light efficiency are in progress.

The Korean patent publication number 2003-0048254, Lee, discloses a single unit package including optical sensor, optical lens, and LED integrally and an optical mouse with the same. However, Lee's single unit optical mouse was not designed so that lightness irradiated is uniform and parallel with the surface irradiated.

The Korean patent publication number 2002-0014430, Choi, discloses a portable wireless information terminal having a pointing device to effectively use application programs with a graphic user interface. However, Choi's portable wireless information terminal adopts a general prism method which irradiates the reflected light onto a contact member after reflecting light from a light source and, therefore, may malfunction because of influx of peripheral disturbance ray into a sensor. In addition, such a prism method cannot make parallel light.

### DISCLOSURE OF INVENTION

### Technical Problem

An object of the present invention is to provide a micro-optical pointing device applicable to a small portable mobile device with high mobility such as a cellular phone and PDA, which can reduce spending of electric power by embodying a pointing device using a lattice type or perceivable pattern as a contact member so as to improve an optical efficiency compared to a method of directly rubbing a finger on a contact member.

Another object of the present invention is to provide a wafer-thin or miniaturized pointing device by using a flip chip in applying a conventional optical mouse for a personal computer to a portable mobile device.

Another object of the present invention is to provide a micro-optical device which can illuminate uniformly a small plane non-perpendicular to the direction of light by adjusting light generated from a light source of a optical device that is designed so that the irradiated lightness is uniform within a irradiation area and becomes parallel light, in illuminating an image acquisition area of a pointing device.

Another object of the present invention is to provide an integrated two-dimensional pointing device, which can be mounted on a small mobile terminal by integrating and packaging the whole optical and other structures within a small space, and maximize light utilization efficiency by concentrating light parallel so that light from a light source is uniformly irradiated on a definite area and blocking disturbance ray.

### Technical Solution

To achieve these objects and other advantages and in accordance with the purpose of the invention, as embodied and broadly described herein, this invention provides a two-dimensional pointing device comprising: a light source emitting light rays to a subject; a contact member comprising a lattice type or perceivable pattern, which reflects an image of the moving subject after receiving light from the light source; a handling surface of image acquisition member, which is positioned on the contact member and has a surface to increase friction force with a finger; an image-formation optical lens, which condenses the light reflected from the contact member and sends the condensed light to an optical sensor; an automatic transfer device which reconveys the contact member moved by the finger; and the optical sensor receiving the image reflected from the optical lens and converting the same into an electronic signal. The contact member having a lattice type or perceivable pattern may be designed so that it can be transferred by an automatic transfer device included in a separate structure. The present invention can reduce power dissipation by forming a handling surface of image acquisition member and a touch sensor over the contact member and making the light source bright only when a finger is contact with the touch sensor. In addition, by blocking light while the pointing device is not used, the present invention prevents a disturbance of user's sight.

Another object of the present invention is achieved by a pointing device comprising a light source emitting light rays to a subject; an image acquisition member having a predetermined area, which reflects light from the light source; an image-formation lens condensing the light reflected from the image acquisition member; a printed circuit board (hereinafter referred to as “PCB”) on which a light source chip, a flip chip, and parts for constituting circuit are mounted, the PCB having an opening thereon to pass an image from the image-formation lens; and the flip chip containing an image sensor which converts an image from the image-formation lens into an electronic signal, and a circuit for signal processing, the flip chip being positioned on the opposite side of the image-formation lens centering on the PCB. Particularly, the pointing device comprising the flip chip in accordance with the present invention is applicable to an electronic device requiring a very small pointing device such as a cellular phone and its size is less than 1□.

Another object of the present invention is achieved by an optical device of a pointing device comprising: a light source emitting light rays to a subject; an integrated optical structure comprising a condensing lens focusing light from the light source, a specular surface reflecting the condensed light, and a light output part passing and outputting the reflected light; and a power and signal connection terminal supplying electricity and exchanging signal with the outside. Here, the light source is attached around the condensing lens and completely enclosed. The power and signal connection terminal is protruded outside.

Another object of the present invention is achieved by an integrated two-dimensional pointing device, comprising a light source emitting light rays to a subject; a parallel light prism lens making light from the light source into parallel light and reflecting the parallel light; a contact member receiving the parallel light from the parallel light prism lens and acquiring a motion image of the subject; an image-formation lens concentrating an image from the contact member; a mask blocking disturbance ray and positioned near the image-formation lens; an image sensor converting the image received from the image-formation lens into an electronic signal; a housing joined to the parallel light prism lens and the image-formation lens integrally; and a PCB on which the image sensor is fixed.

### BRIEF DESCRIPTION OF THE DRAWINGS

FIG. 1 is a schematic diagram illustrating a conventional pointing device.

FIG. 2 shows a pointing device having an automatic transfer device in accordance with the present invention.

FIG. 3 is a cross-sectional view illustrating a guard line of a contact member in accordance with the present invention.

FIG. 4 is a schematic diagram illustrating a handling surface of an image acquisition member and a touch sensor in accordance with the present invention.

FIG. 5 is a schematic diagram illustrating a touch sensor in accordance with the present invention.

FIG. 6 illustrates an example of a pointing device having an automatic transfer device in accordance with the present invention.

FIG. 7 is a diagram illustrating a layout of a flip chip in accordance with the present invention.

FIG. 8 is a cross-sectional view illustrating a pointing device with a flip chip in accordance with the present invention.

FIG. 9 is a schematic diagram illustrating an optical device to uniformly irradiate a small plane which is not perpendicular to the direction of light generated from a light source in accordance with the present invention.

FIG. 10 is a schematic diagram illustrating an image acquisition part of an optical image acquisition device using the optical device of FIG. 9.

FIG. 11 is a cross-sectional view illustrating an integrated two-dimensional pointing device in accordance with the present invention.

FIG. 12 is an exploded view illustrating an integrated two-dimensional pointing device in accordance with the present invention.

FIG. 13 is a front perspective view illustrating an example of an integrated two-dimensional pointing device in accordance with the present invention.

FIG. 14 is a rear perspective view illustrating an example of an integrated optical image acquisition device in accordance with the present invention.

FIG. 15 is a schematic diagram illustrating a light guide structure of an integrated two-dimensional pointing device.

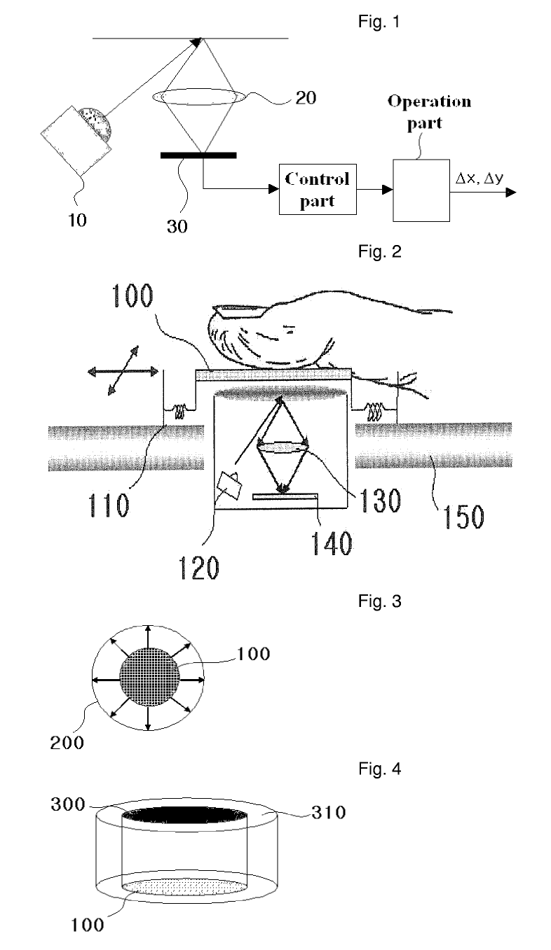

### BEST MODE FOR CARRYING OUT THE INVENTION

Further objects and advantages of the invention can be more fully understood from the following detailed description taken in conjunction with the accompanying drawings.

FIG. 2 is a schematic diagram illustrating an automatic transfer device of a pointing device in accordance with the present invention.

Referring to FIG. 2, light from a light source (120) is irradiated to a contact member (100). A subject is in contact with the contact member (100). The light reflected from the contact member (100) passes through an image-formation lens (130) to form an image onto an optical sensor (140). Here, the contact member (100) comprises a lattice type or perceivable pattern.

The contact member (100) may be moved by an automatic transfer device (110) which is installed into a separate structure such as a PCB (150) or key pad of a cellular phone. The automatic transfer device (110) is formed of elastic material such as rubber or silicon, or magnetic material. The contact member (100) is moved on a plane by elasticity in case of elastic material or magnetism in case of magnetic material.

FIG. 3 is a cross-sectional view illustrating a guard line of the contact member in accordance with the present invention. Referring to FIG. 3, the contact member (100) is positioned in the center of a guard line (200) and can be moved in all directions within the guard line (200). The automatic transfer device made of elastic or magnetic material is positioned around the contact member (100). Therefore, a user can move the contact member (100) in a desired direction and the contact member (100) is restored to an original position by elasticity or magnetism unless the user apply force to the contact member (100).

FIG. 4 is a schematic diagram illustrating a handling surface of image acquisition member and a touch sensor in accordance with the present invention. The handling surface of image acquisition member (300) is used to operate the contact member (100). The handling surface of image acquisition member (300) is positioned just over the contact member (100). The handling surface of image acquisition member (300) and the contact member (100) are moved simultaneously. The touch sensor (310) is positioned around the handling surface of image acquisition member (300), perceiving as an operation state when a finger is in contact with the handling surface of image acquisition member. Thus, by increasing brightness of the light source only in case of operation state, the present invention can reduce power dissipation. The handling surface of image acquisition member (300) may be made from rubber or have a surface prominence structure and, therefore, a user can readily operate the handling surface of image acquisition member.

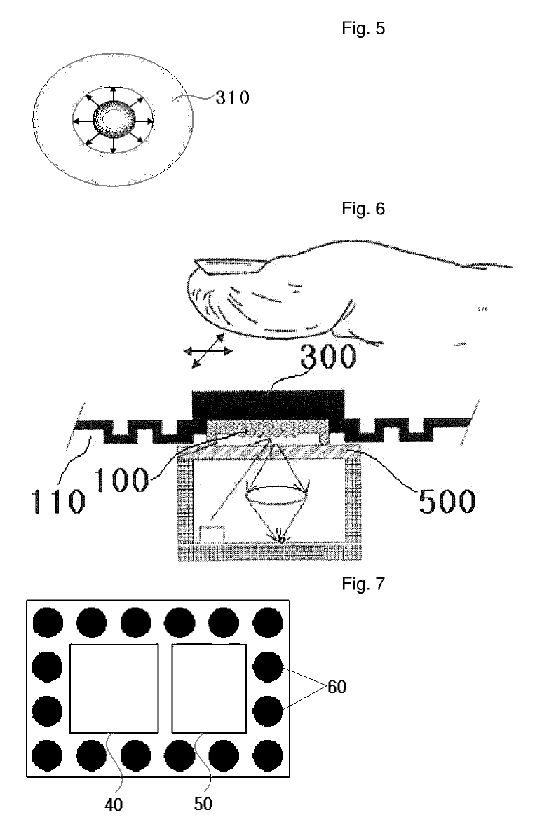

FIG. 5 is a schematic diagram illustrating a touch sensor in accordance with the present invention. Referring to FIG. 5, the touch sensor is positioned so as to enclose the guard line in which the handling surface of image acquisition member and the contact member are moved. Thus, the touch sensor (310) can directly perceive whether a finger is in contact with the handling surface of image acquisition member or not. When the contact member is restored to an original position by the automatic transfer device while a finger is not in contact with the touch sensor, the pointing device does not perceive such a restoration as movement. The pointing device perceives that there is no operation to the handling surface of image acquisition member when the restoring speed of the contact member is larger than a predetermined value.

In addition, the pointing device in accordance with the present invention does not need a separate click button because the touch sensor (310) has a function of a click b utton. In detail, when a user presses the touch sensor (310) twice continuously in a pre-determined period of time, the touch sensor functions as a click button. In this case, the effective movement of the contact member while it is restored to an original location may be calculated by subtracting the movement of the contact member while a finger is away from the touch sensor from the whole movement of the contact member.

FIG. 6 illustrates an example of a pointing device having an automatic transfer device in accordance with the present invention. Referring to FIG. 6, the contact member (100) is positioned under the handling surface of image acquisition member (300) which has a surface prominence structure or is made of rubber for smooth operation so that the contact member (100) can be moved with the handling surface of image acquisition area (300). Here, a structure (500) made of transparent material may be formed under the contact member (100) so that the contact member (100) can be more smoothly moved. The handling surface of image acquisition member (300) and the contact member (100) are freely moved within the guard line by the automatic transfer device (110). The automatic transfer device (110) is preferably made from elastic material such as rubber or silicon or magnetic material. In addition, the automatic transfer device (110) may have structure with flections or grooves for smooth transfer or restoration.

FIG. 7 is a diagram illustrating a layout of a flip chip in accordance with the present invention. To form a micro-optical pointing device, a packing technology of a wafer-size level has to be applied. FIG. 7 shows a layout of a sensor packaged in a wafer-size level. Referring to FIG. 7, a CMOS image sensor (40) for forming an image and a processing unit (50), which converts the signals from the CMOS image sensor (40) into two-dimensional moving data, are included into a single chip. A circuit is formed on a predetermined region of a wafer except the region of the image sensor. Then, bonding pads (60) are arranged around the image sensor (40) and the operating unit (50). Solder balls are attached to the bonding pads to complete a flip chip. The sensor flip chip and a light source chip such as an LED are mounted on a circuit board by using an automatic surface mount device to form a low-cost circuit structure. Such a circuit structure can be easily and tightly coupled with an integrated optical structure. Therefore, the present invention can reduce production costs and improve quality by easily embodying such a waterproof and dustproof structure.

Particularly, by containing a wafer-thin circuit formed by applying a redistribution layer (hereinafter referred to as “RDL”) method on the surface of a wafer, the flip chip according to the present invention can be directly connected with a PCB of a pointing device without using an auxiliary PCB.

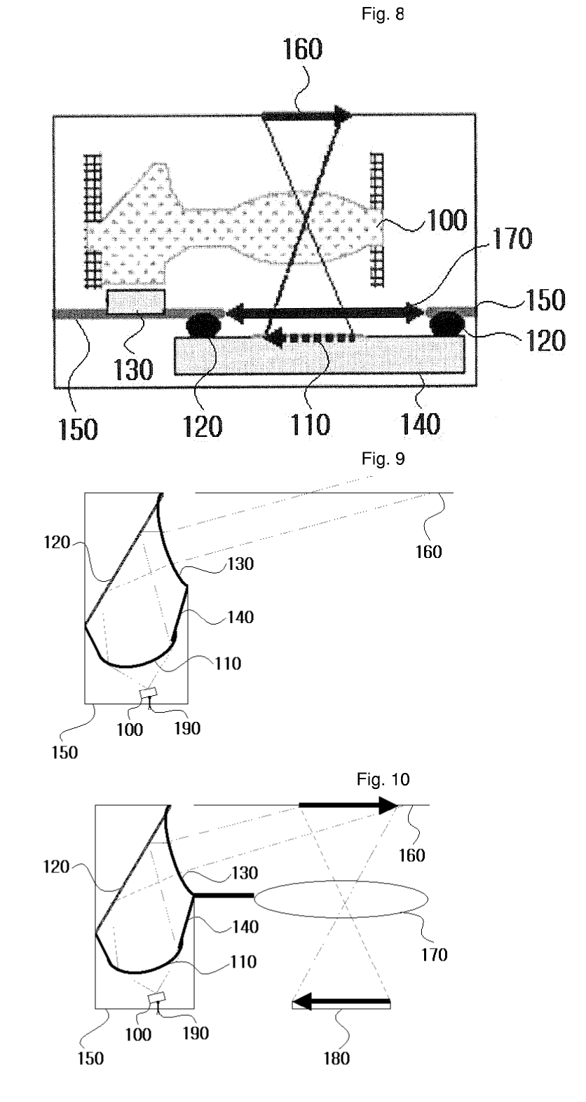

FIG. 8 is a cross-sectional view illustrating a pointing device with a flip chip in accordance with the present invention. Referring to FIG. 8, the flip chip (140) is a semi-conductor chip containing an image sensor (110) and a circuit for signal processing. Solder bumps (120) is used to mount the flip chip (140) on a small circuit board and to electrically connect. Various parts for constituting other circuits are mounted on the PCB (150).

The solder bumps (120) are used to mount the flip chip (140) on a substrate. The solder bumps (120) are directly fused on a soldering surface of the substrate to attach the flip chip (140) to the PCB (150). In view of structure, the flip chip (140) is positioned under the PCB (150) and an image-formation lens (100) for acquiring an image of a subject is installed on the PCB (150). Centering on the PCB (150), the flip chip (140) is located on the opposite side of the image-formation lens (100). The image-formation lens (100) is preferably a holographic lens or aspheric lens.

The flip chip (140) contains the image sensor (110). The PCB (150) has an opening (170) thereon. The opening (170) is formed just over the image sensor (110). A light source (130) and at least one resistance are integrally mounted on the PCB (150). The light source (130) is preferably an LED, a laser diode, or an organic electroluminiscence (hereinafter referred to as “organic EL”). The resistance used is preferably more than one. The image sensor (110) is preferably a CMOS image sensor or a charge-coupled device (hereinafter referred to as “CCD”) image sensor.

The opening (170) of the PCB (150) is made of transparent material to protect the flip chip (140) from pollutants or dusts. The opening (170) may further comprise an optical filter to intercept unnecessary light.

In detail, light generated from the light source (130) is uniformly irradiated to the image acquisition member (160) on which a subject is placed. The light is reflected according to the optical pattern of the image acquisition member (160). The light reflected from the image acquisition member (160) passes through the image-formation lens (100) and the opening (170) of the PCB (150) and, then, forms an image on the surface of the image sensor (110). The image formed on the image sensor (110) is converted into an electronic signal by the image sensor (110). Then, the electronic signal is inputted in a signal processing unit and converted into a digital image.

In the above-described pointing device, image acquisition is progressed very rapidly on a time axis. Here, a motion estimation method is used to detect quantity of change in movement by comparing images formed between adjacent times. As described above, by acquiring an image from the image-acquisition member on which a subject is placed and analyzing the change of the images acquired according to the lapse of time, the present invention can embody a pointing device like a mouse for a personal computer.

FIG. 9 is a schematic diagram illustrating a lighting device of an optical mouse to uniformly irradiate a small plane which is not perpendicular to the direction of light generated from a light source in accordance with the present invention. Referring to FIG. 9, the light source (100) is relatively small in size compared to the whole optical structure. A condensing lens (110) concentrates the light generated from the light source (100) and, then, sends the concentrated light to a specular surface (120). The specular surface (120) is a total reflection plane or mirror plane covered with a reflection film according to the refractive index of an optical material. The specular surface (120) reflects the incident light. The light output part (130) is a plane or concave lens-shaped. In the light output part (130), the incident light is changed into parallel light. An optical material member (140) is connected to the condensing lens (110), the specular surface (120), and the light output part (130). The light source (100) is tightly enclosed near the condensing lens (110). A power connection terminal (190) for supplying the light source (100) with electricity is projected outside.

The light source (100) is positioned near the focus of the condensing lens (110). The light generated from the light source (100) is concentrated by the condensing lens (110). The concentrated light reaches the specular surface (120) and is reflected again. The reflected light is outputted through the light output part (130) and irradiates the image acquisition member (160).

The above-described optical device structure can achieve relatively uniform luminance within the image acquisition member (160) because the structure can form nearly parallel light and, therefore, the intensity of light hardly changes according to distance. In the pointing device according to the present invention, the chief direction of light generated from the light source (100) becomes different from the chief direction of the light outputted.

By reducing an angle between the image acquisition member (160) and the direction of light outputted, small prominence and depression of the subject placed on the image acquisition member (160) make a large shadow and, therefore, the subject on the image acquisition member (160) can be well discriminated optically. An integration member (150) is used to fix the light source (100) and optical parts (110˜140) and prevent an inflow of external light into the inside and an effluence of internal light to the outside through a region except output area. The integration member (150) is formed into a integral structure with an optical shield or a structure with a similar function, and can be combined with a PCB or similar circuit.

When the light source having the above-described structure is used as a lighting device of an optical mouse, the lighting device is applicable to a portable terminal (for example, cellular phone, PDA, etc.) containing an optical mouse function. Here, the light source is preferably an LED, laser diode, or organic EL.

FIG. 10 is a schematic diagram illustrating an image acquisition part of an optical image acquisition device using the optical device of FIG. 9. Referring to FIG. 10, an image-formation lens (170) is used to form an image from an image-acquisition member (160) on an image sensor (180). In detail, light generated from the light source (100) is concentrated through a spherical or aspheric lens (110) and, then, reflected on a specular surface (120). The reflected light is outputted through an output part (130). The parallel light outputted through the output part (130) is irradiated to the image acquisition member (160) to form an image. The image-formation lens (170) is preferably a convex or aspheric lens.

The optical parts (110˜140) for lighting and optical part (170) for image-formation in accordance with the present invention may be formed into different parts or one part. To form the optical parts (110˜140) for lighting and the image-formation lens (170) as one part, a PCB or a circuit with similar function is used. Here, the optical parts (110˜140) and the image-formation lens are mounted on the PCB or circuit as a single part.

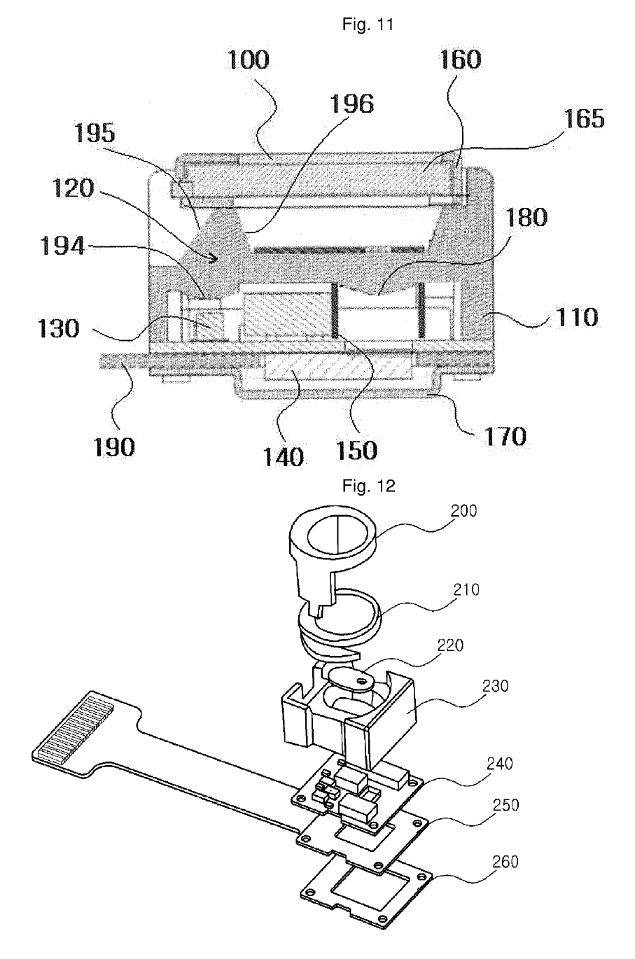

FIG. 11 shows another embodiment of an integrated two-dimensional pointing device in accordance with the present invention. In detail, FIG. 11 is a cross-sectional view illustrating an integrated two-dimensional pointing device comprising an integrated optical device. Referring to FIG. 11, the integrated optical device comprises a parallel light prism lens (120) for making light from a light source (130) parallel so as to uniformly irradiate the light to an optical pad, i.e., a contact member (165); a mask (150) for preventing the input of disturbance ray; and an image-formation lens (180) for concentrating the image from the contact member (165). The parallel light prism lens (120), the mask (150), and the image-formation lens (180) are formed into a single part. The parallel light prism lens (120) comprises an incidence plane (194) through which light from the light source enters, a specular surface (195) which reflects the light from the incidence plane (194) to the contact member (165), and an exit surface (196) through which the light reflected from the specular surface (195) passes.

An integrated optical device comprising the parallel light prism lens (120), the mask (150) and the image-formation lens (180), i.e., a light guide structure is again combined with a housing (110) to form an integrated structure. Such a structure can minimize occurrence of defects due to tolerance during assembling, thereby improving efficiency of work and productivity.

By combining the light guide structure including the housing with a touch sensor, an image sensor, and a PCB for fixing the image sensor, an integrated two-dimensional pointing device is completed. As shown in FIG. 11, the touch sensor (160) is positioned around the handling surface of image acquisition member over the contact member (165). The pointing device perceives as an operation state only when a finger is in contact with the touch sensor (160). Therefore, by increasing the brightness of light source in case of operation state, the power dissipation can be reduced. The image sensor (140) positioned under the image-formation lens (180) converts the image into an electronic signal. The image sensor (140) is fixed to a PCB (190) and an image sensor protection structure (170) is installed under the image sensor (140).

The light source (130) is installed between the PCB (190) and the parallel light prism lens (120). The contact member (165) positioned over the light guide structure and the housing (110) may be covered with hard coating to prevent scratch or abrasion due to external force or manufactured by using an inmold method which projects after adhesion of a film (100). The parallel light prism lens (120) preferably comprises a prism and more than one lens to improve an optical efficiency.

Consequently, over the PCB (190) combined with the image sensor (140), the contact member (165) and the light guide/housing (110) integration structure are formed and connected to protect the lower part of the pointing device. The light guide, housing (110), and contact member (165) are preferably made from the same material, more preferably, optical plastic such as polymethylmethacrylate (hereinafter referred to as “PMME”) or poly-carbonate (hereafter referred to as “PC”).

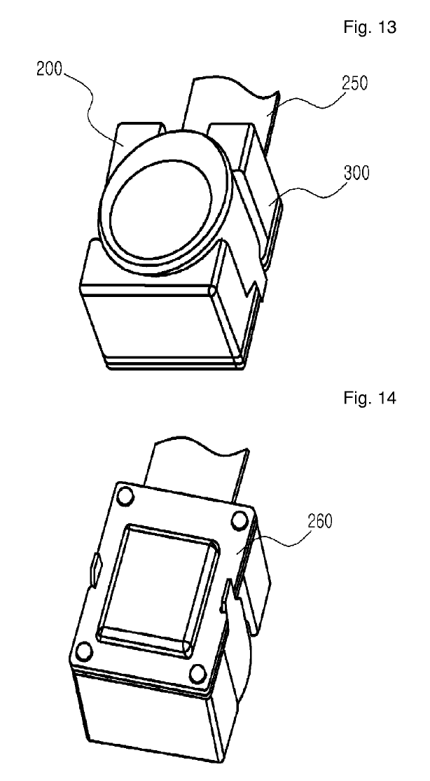

FIG. 12 is an exploded view illustrating an integrated two-dimensional pointing device in accordance with the present invention. FIG. 12 shows a touch sensor (200), a contact member (210), a mask (220), a housing (230), a PCB (240), a flexible printed circuit board (hereinafter, referred to as “FPCB”) (250), and an image sensor protection structure (260) in accordance with the present invention. In detail, a structure consisting of the lens, housing, image sensor, PCB, and contact member as shown in FIG. 11 is mounted on the FPCB (250). The FPCB couples the PCB with a connector joined on a corresponding portable electronics such as a cellular phone. The FPCB (250) is widely employed in designing miniaturized and complicated electronic devices. The FPCB (250) is readily processed and has high heat resistance, flexible resistance, and chemical resistance. By using the FPCB (250), time is saved in an assembly process. Instead of the FPCB (250), a socket and pin may be used.

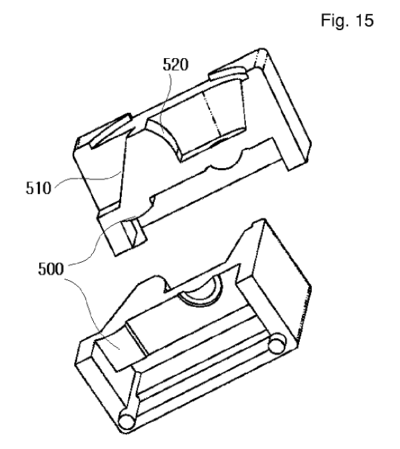

FIG. 13 is a front perspective view illustrating an example of an integrated two-dimensional pointing device in accordance with the present invention. Referring to FIG. 13, the optical structure (130) including the components of FIG. 11 and touch sensor (200) are made from a conductive material so as to perceive on/off of the pointing device and transfer it to a circuit. The optical structure (300) is in contact with the PCB to send an electronic signal to a circuit in the moment of touch. In another embodiment, the FPCB (250), touch sensor (200), and PCB may be connected together.

FIG. 14 is a rear perspective view illustrating an example of an integrated two-dimensional pointing device in accordance with the present invention. Referring to FIG. 14, the image sensor protection structure (260) may be integrally formed adding to the housing integration structure. The image sensor protection structure (260) is positioned under the image sensor to protect the image sensor from external impacts or dusts and foreign substance.

FIG. 15 is a schematic diagram illustrating a parallel light prism lens of a light guide structure in accordance with the present invention. Referring to FIG. 15, the parallel light prism lens according to the present invention is a free-shaped prism comprising a cylinder type incidence plane (500) which converts diverged rays of a lambertian light source into parallel rays, a cylinder type specular surface (510) which changes the light path from the incidence plane to a contact member and also forms parallel rays into more parallelized rays, and a cylinder type exit plane (520) which evenly distributes parallel rays to a contact member. The incidence plane (500), specular surface (510), and exit plane (520) have to be arranged so as to have a three-dimensional optical path, as shown in FIG. 15, in order to concentrate the light on the contact member and obtain uniform luminance.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

### INDUSTRIAL APPLICABILITY

Accordingly, by manufacturing a micro-optical pointing device using a contact member with a lattice type or perceivable pattern, the present invention can reduce power dissipation of the pointing device, thereby increasing the operating time of an electronic device with a secondary battery such as mobile communication terminal or PDA. By employing a flip chip instead of wire bonding requiring an auxiliary circuit board, the present invention can automate a mount process of other circuits such as a light source and flip chip together with the flip chip on the PCB and simplify the production process, thereby contributing for cost reduction. In addition, by using the flip chip, the present invention can manufacture a micro-optical or wafer-thin pointing device which is applicable to a small portable electronic device.

By irradiating a plane arranged at an acute angle with the direction of light using parallel light generated from an integrated light source package, the pointing device of the present invention can make uniform lightness and large shadows even from small prominence and depression of a subject so that the small prominence and depression can be readily detected. Moreover, the present invention can transfer light from a light source to an optical sensor without loss and protect optical lenses and sensor from defects due to malfunction of sensor, dusts, or foreign substances. The present invention can improve light efficiency by maximizing irradiation efficiency using parallel light and by fundamentally preventing malfunction of sensor using a mask capable of blocking unnecessary disturbance ray. In addition, the present invention can reduce power dissipation of sensor by applying efficiently the light from the light source. Finally, by forming integrally lenses and housing, the present invention can minimize occurrence of defects due to tolerance for moving and assembly of precision parts such as lenses, thereby improving operation efficiency and productivity.

1. A two-dimensional pointing device comprising:
a light source emitting light rays to a subject;
a contact member comprising a lattice type or perceivable pattern, the contact member reflecting an image of the moving subject after receiving the light from the light source;
a handling surface of image acquisition member positioned on the contact member, the handling surface of image acquisition member having a surface to increase friction force with a finger;
an image-formation optical lens condensing the light reflected from the contact member and sending the condensed light to an optical sensor;
an automatic transfer device restoring the contact member moved by the finger; and
the optical sensor receiving the image reflected from the optical lens and converting the image into an electronic signal.

2. The two-dimensional pointing device as defined by claim 1, wherein the handling surface of image acquisition member is made from rubber or has a surface prominence structure.

3. The two-dimensional pointing device as defined by claim 1, wherein the pointing device perceives that there is no operation when the restoring speed by the automatic transfer device is larger than a predetermined value.

4. The two-dimensional pointing device as defined by claim 1, wherein the automatic transfer device is formed of elastic material or magnetic material.

5. The two-dimensional pointing device as defined by claim 4, wherein the elastic material comprises rubber or silicon.

6. The two-dimensional pointing device as defined by claim 1, further comprising a touch sensor positioned around the contact member, wherein the touch sensor determines whether the pointing device is used or not according to whether a finger is in contact with the touch sensor or not.

7. The two-dimensional pointing device as defined by claim 6, wherein the touch sensor is used as a click button.

8. The two-dimensional pointing device as defined by claim 7, wherein the touch sensor is used as a click button when a finger is in contact with the touch sensor twice continuously in a predetermined period of time.

9. The two-dimensional pointing device as defined by claim 7, wherein the effective movement of the contact member is calculated by subtracting the movement of the contact member while the finger is away from the touch sensor from the whole movement of the contact member when the touch sensor is used as a click button.

10. The two-dimensional pointing device as defined by claim 1, further comprising a structure made from a transparent material, the structure being positioned under the contact member so that the contact member can be smoothly moved.

11. A two-dimensional pointing device comprising:
a light source emitting light rays to a subject;
an image acquisition member having a predetermined area, the image acquisition member reflecting light from the light source;
an image-formation lens condensing the light reflected from the image acquisition member;
a PCB on which a light source chip, a flip chip, and parts for constituting circuit are mounted, the PCB having an opening to pass an image from the image-formation lens; and
the flip chip containing an image sensor, which converts an image from the image-formation lens into an electronic signal, and a circuit for signal processing, the flip chip being positioned on the opposite side of the image-formation lens centering on the PCB.

12. The two-dimensional pointing device as defined by claim 11, wherein the flip chip is directly combined with the PCB of the pointing device without using an auxiliary PCB by containing a wafer-thin circuit formed using an RDL method on the surface of a wafer.

13. The two-dimensional pointing device as defined by claim 11, wherein the opening is formed of a transparent material.

14. The two-dimensional pointing device as defined by claim 11, further comprising an optical filter to intercept light unnecessary for the opening.

15. An optical device of a pointing device, comprising:
a light source emitting light rays to a subject;
an integrated optical structure comprising a condensing lens focusing light from the light source, a specular surface reflecting the condensed light, and a light output part passing and outputting the reflected light; and
a power and signal connection terminal supplying electricity and exchanging signal with the outside, the power and signal connection terminal being protruded outside.

16. The optical device of a pointing device as defined by claim 15, further comprising an optical system acquiring, condensing, and forming an image from the image acquisition member.

17. The optical device of a pointing device as defined by claim 16, wherein the optical system consisting of a light source, a condensing lens, a specular surface, and an optical output part, is formed into an integrated structure using a PCB or a circuit with similar functions.

18. The optical device of a pointing device as defined by claim 15, wherein the chief direction of light generated from the light source is different from the chief direction of the light outputted.

19. The optical device of a pointing device as defined by claim 15, wherein the specular surface is a total reflection plane or mirror plane.

20. The optical device of a pointing device as defined by claim 15, wherein the light output part is a plane or a concave-shaped or cylinder-shaped lens.

21. The optical device of a pointing device as defined by claim 15, wherein the integrated optical structure prevents an inflow of external light into the inside and an effluence of internal light into the outside through a region except output area.

22. An integrated two-dimensional pointing device comprising:
a light source emitting light rays to a subject;
a parallel light prism lens making light from the light source into parallel light and reflecting the parallel light;
a contact member receiving the parallel light from the parallel light prism lens and acquiring a motion image of the subject;
an image-formation lens concentrating an image from the contact member;
a mask blocking disturbance ray, the mask being positioned near the image-formation lens
an image sensor converting the image received from the image-formation lens into an electronic signal;
a housing integrally joined to the parallel light prism lens and the image-formation lens; and
a PCB on which the image sensor is fixed.

23. The integrated two-dimensional pointing device as defined by claim 22, further comprising an image sensor protection structure positioned under the image sensor to protect the image sensor.

24. The integrated two-dimensional pointing device as defined by claim 22, further comprising a touch sensor positioned around the contact member, wherein the touch sensor determines whether the pointing device is used or not according to whether a finger is in contact with the touch sensor or not.

25. The integrated two-dimensional pointing device as defined by claim 24, wherein the light source is turned off to be switched to a power saving mode when the finger is not in contact with the touch sensor.

26. The integrated two-dimensional pointing device as defined by claim 22, wherein the contact member is covered with hard coating or manufactured by using an inmold method which projects after adhesion of a film.

27. The integrated two-dimensional pointing device as defined by claim 22, wherein the contact member is formed of optical plastics of PMME or PC.

28. The integrated two-dimensional pointing device as defined by claim 22, wherein the parallel light prism lens, the image-formation lens, and the mask are formed into a single part of a light guide structure.

29. The integrated two-dimensional pointing device as defined by claim 28, wherein the light guide structure is formed of the same material with the contact member.

30. The integrated two-dimensional pointing device as defined by claim 22, wherein the parallel light prism lens is a halfround-shaped lens comprising an incidence plane, a specular surface, and an exit plane.

31. The integrated two-dimensional pointing device as defined by claim 22, wherein the parallel light prism lens comprises a prism and more than one lens.

32. The integrated two-dimensional pointing device as defined by claim 22, wherein the parallel light prism lens and the image-formation lens are formed into an integrated structure.

33. The integrated two-dimensional pointing device as defined by claim 22, further comprising:
a connector to join on a corresponding portable electronics; and
an FPCB connecting the PCB with the connector.
